(19) United States
(12) Patent Application Publication
(10) Pub. No.: US 2020/0328502 A1
(43) Pub. Date: Oct. 15, 2020

(54) ANTENNA INCLUDING CARRIER FORMED USING A COMPOSITE PLASTIC MATERIAL HAVING A DIELECTRIC CONSTANT WITHIN A SPECIFIC RANGE

(71) Applicant: Amphenol Taiwan Corporation, Taoyuan City (TW)

(72) Inventors: Shu-Te Tai, Taoyuan City (TW); Chee Ming Eea, Taoyuan City (TW); Yu-Hsun Huang, Taoyuan City (TW); Feng-Pin Chang, Kaohsiung City (TW)

(21) Appl. No.: 16/653,925

(22) Filed: Oct. 15, 2019

(30) Foreign Application Priority Data
Apr. 12, 2019 (TW) 108112798
Jul. 17, 2019 (TW) 108125303

(51) Int. Cl. H01Q 1/24; H01Q 1/38; H01Q 5/30; H01Q 9/30; H01Q 9/04; H01Q 7/00; H01Q 13/10

(52) U.S. Cl. CPC H01Q 1/243; H01Q 1/38; H01Q 5/30; H01Q 13/10; H01Q 9/0421; H01Q 7/00; H01Q 9/30

(57) ABSTRACT

An antenna includes a carrier and at least one conductive component. The carrier may be formed using a composite plastic material. The carrier may provide at least one containing area. The composite plastic material may have a dielectric constant. The at least one conductive component may be formed at the at least one containing area to be combined with the carrier. The at least one conductive component may form a pattern. The dielectric constant may be between a first value and a second value where the first value and the second value are larger than zero, and the first value is smaller than the second value. The first value is substantially six.

### BACKGROUND OF THE INVENTION

### 1. Field of the Invention

The disclosure is related to an antenna, and more particularly, an antenna including a carrier formed using a composite plastic material having a dielectric constant within a specific range.

### 2. Description of the Prior Art

As the demand of wireless communications increases and the technology advances, the requirements related to antennas also grow. Currently, a common application of wireless communications is with a portable device.

Antenna performance can be assessed by evaluating the voltage standing wave ratio (VSWR) and the efficiency curve of the antenna. FIG. 1 illustrates a diagram of VSWR of an antenna according to prior art. FIG. 2 illustrates an efficiency curve of an antenna according to prior art.

Because the size and weight of a portable device are often limited, the size of an antenna is to be reduced. However, if the size of an antenna is directly reduced, the transceiver ability will be affected, and the antenna performance will deteriorate. Hence, there is a need to reduce the size of an antenna without lowering the antenna performance.

### SUMMARY OF THE INVENTION

An embodiment provides an antenna including a carrier and at least one conductive component. The carrier is formed using a composite plastic material and used to provide at least one containing area where the composite plastic material has a dielectric constant. The at least one conductive component is formed at the at least one containing area for combining with the carrier where the at least one conductive component forms a pattern. The dielectric constant is between a first value and a second value. The first value and the second value are larger than zero. The first value is smaller than the second value, and the first value is substantially equal to or larger than six.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of voltage standing wave ratio (VSWR) of an antenna according to prior art.

FIG. 2 illustrates an efficiency curve of an antenna according to prior art.

FIG. 3 illustrates a first view of an antenna according to an embodiment.

FIG. 4 illustrates a second view of the antenna in FIG. 3.

FIG. 5 illustrates a third view of the antenna in FIG. 3.

FIG. 6 illustrates a diagram of VSWR of the antenna in FIG. 3.

FIG. 7 illustrates an efficiency curve of the antenna in FIG. 3.

FIG. 8 illustrates an antenna according to another embodiment.

FIG. 9 illustrates an antenna according to another embodiment.

FIG. 10 illustrates a diagram of VSWR of the antenna in FIG. 8.

FIG. 11 illustrates a diagram of VSWR of the antenna in FIG. 9.

FIG. 12 illustrates an efficiency curve of the antenna in FIG. 8.

FIG. 13 illustrates an efficiency curve of the antenna in FIG. 9.

FIG. 14 illustrates an antenna according to another embodiment.

FIG. 15 illustrates an antenna according to another embodiment.

### DETAILED DESCRIPTION

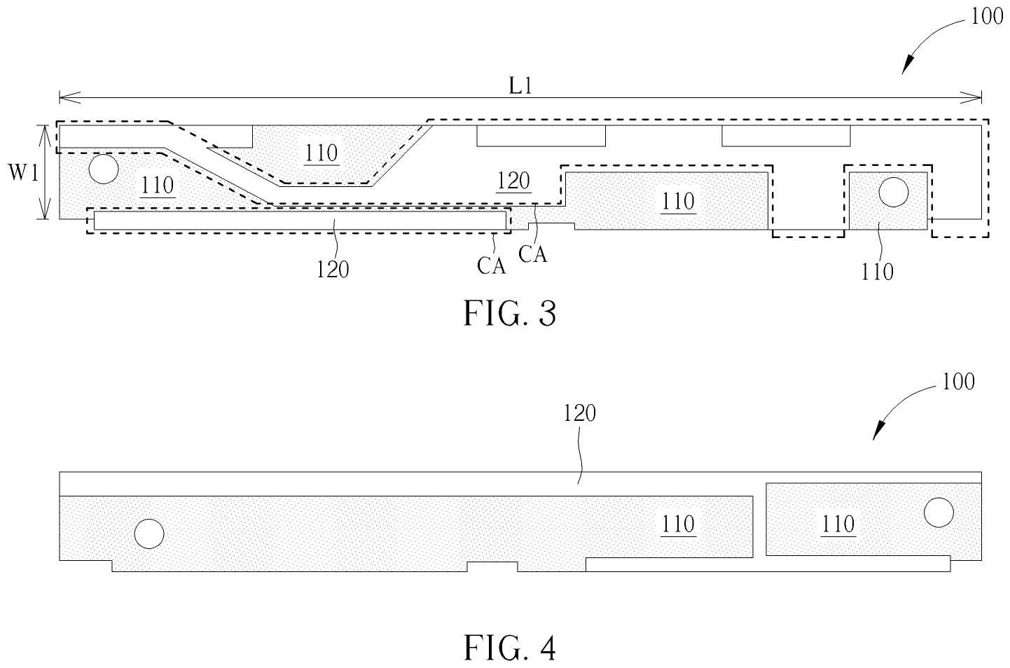

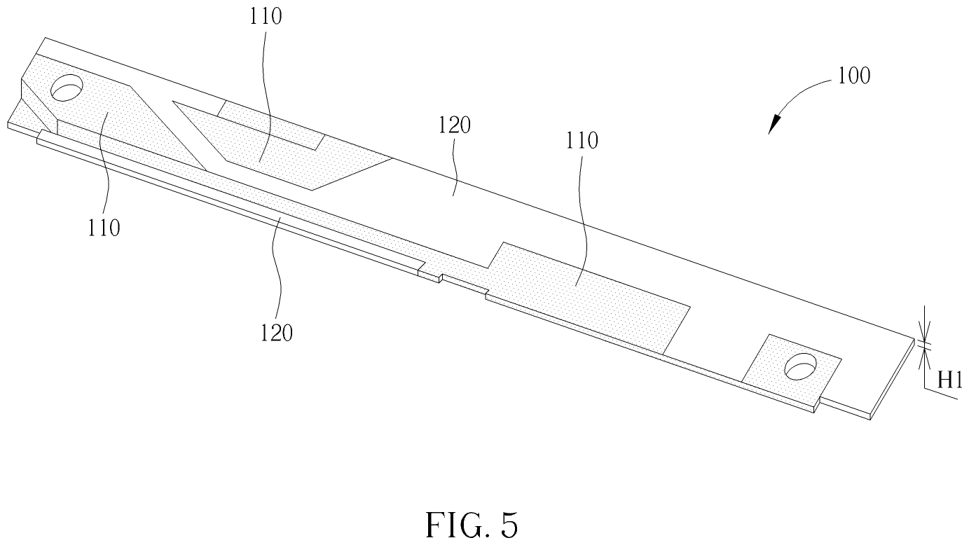

FIG. 3 illustrates a first view of an antenna 100 according to an embodiment. FIG. 4 illustrates a second view of the antenna 100. FIG. 5 illustrates a third view of the antenna 100. FIG. 3, FIG. 4 and FIG. 5 may respectively provide a top view, a bottom view and a perspective view of the antenna 100 to illustrate a structure of the antenna 100.

The antenna 100 may include a carrier 110 and at least one conductive component 120. The carrier 110 may be formed using a composite plastic material. The carrier 110 may provide at least one containing area CA. The composite plastic material used to form the carrier 110 may have a dielectric constant ε. The conductive component 120 may be formed at the containing area CA for combining with the carrier 110. The conductive component 120 may form a pattern.

The dielectric constant ε may be between a first value V1 and a second value V2. The first value V1 and the second value V2 may be larger than zero, and the first value V1 may be smaller than the second value V2. Namely, the dielectric constant ε may be expressed by the equation (eq-1):

0<V1≤ε≤V2 (eq-1)

According to an embodiment, the first value is substantially equal to six and the second value is substantially equal to 10 according to results of research and experiments. Hence, the dielectric constant εof the composite plastic material used to form the carrier 110 may be expressed by the equation (eq-2):

6≤ε≤10 (eq-2).

As described below, by adjusting the dielectric constant ε of the composite plastic material used to form the carrier 110, the size of the antenna may be reduced without losing the antenna performance.

In the antenna 100, the carrier 110 and the conductive component 120 may be generated and combined with one another using a laser direct structuring (LDS) process. For example, a thermoplastic composite plastic material may be injected and shaped to form the carrier 110 first with an injection molding process. Then, a laser activation operation may be performed by applying special chemical additive and applying a laser beam to activate the materials to induce a physical-chemical reaction to form metallic nuclei. By means of the operation, metal (such as, but not limited to copper) may be firmly anchored on the composite plastic material during metallization. Metallization may be further performed on the surface of the processed composite plastic material. For example, metal such as copper (Cu), nickel (Ni) and/or Gold (Au) may be plated according to requirements. By means of the above process, the conductive component 120 formed of a conductor (e.g., metal) may be disposed in the planned containing area CA. The carrier 110 and the conductive component 120 may form a molded interconnect device (MID) including a conductive path. The antenna 100 of FIG. 3 may be manufactured using an LDS process to be assembled with another circuit.

In addition to an LDS process, the carrier 110 and the conductive component 120 may be generated and combined to one another using a flexible print circuit board, a metal stamping process or a metal spraying process.

For example, a dielectric constant of a plastic material of prior art may be approximately equal to three. If using a plastic material with a dielectric constant of 3 to form the antenna of FIG. 3 and operating the antenna in a frequency band of around 1 Gigahertz (GHz), the antenna may have a length of 11 millimeters (mm), a width of 85 mm, and a height of 5 mm. Hence, the antenna of prior art may occupy an area of 935 square millimeters (mm²) and have a volume of 4675 cubic millimeters (mm³). However, as shown in FIG. 3, the antenna 100 may have a length L1 and a width W1 after the carrier 110 and the conductive component 120 are combined with one another. For example, the length may be measured along a horizontal direction in FIG. 3, and the width may be measured along a vertical direction in FIG. 3. When the dielectric constant of the composite plastic material is between six and seven, the antenna 100 may be operated in a frequency band of approximate 1 GHz, the length L1 may be substantially less than 85 mm, the width W1 may be substantially less than 9.5 mm, and the thickness H1 (as shown in FIG. 5) may be substantially less than 4.5 mm. For example, the length L1 may be substantially 80 mm. Hence, the antenna 100 may occupy an area of around 760 mm² and have a volume of around 3420 mm³ when the dielectric constant of the composite plastic material is between six and seven. When the dielectric constant of the composite plastic material is between seven and ten, the antenna 100 may be operated in a frequency band of approximate 1 GHz, the length L1 may be substantially less than 85 mm, the width W1 may be substantially less than 9.5 mm, and the thickness H1 may be substantially less than 3.9 mm. For example, the length L1 may be substantially 76 mm, and the width W1 may be substantially 8.5 mm. Hence, the antenna 100 may occupy an area of around 646 mm² and have a volume of around 2520 mm³ when the dielectric constant of the composite plastic material is between seven and ten.

Hence, according to embodiments, the antenna 100 including the carrier 110 with the dielectric constant of 6 to 7 may occupy an area which is 760/935 (i.e. 81.28%) of the area occupied by the antenna of prior art. The antenna 100 including the carrier 110 with the dielectric constant of 7 to 10 may occupy an area which is 646/935 (i.e. 69.09%) of the area occupied by the antenna of prior art. The antenna 100 including the carrier 110 with the dielectric constant of 6 to 7 may have a volume which is 3420/4675 (i.e. 73.15%) of the volume of the antenna of prior art. The antenna 100 including the carrier 110 with the dielectric constant of 7 to 10 may have a volume which is 2520/4675 (i.e. 53.9%) of the volume of the antenna of prior art. The sizes and ratios of reduction described above are merely examples.

Hence, if an antenna of prior art without utilizing a solution of an embodiment is defined as an original antenna, the antenna 100 may occupy at least 30% less area than the original antenna, and the antenna 100 may be at least 45% smaller than the original antenna.

Regarding the conductive component 120 of the antenna 100, the conductive component 120 may have a length and a width, the length may be substantially less than 85 mm, and the width may be substantially less than 25 mm. For example, an antenna including the conductive 120 having a size within this range may support applications related to 5G mobile communications. Hence, the size of the conductive component 120 of the antenna is effectively reduced.

As mentioned above, antenna size is to be reduced. However, if an antenna is directly shrunk in size, the antenna performance would deteriorate. According to an embodiment, by using an antenna including a carrier formed by a composite plastic material having a dielectric constant within a specific range (e.g., a range of six to ten), the antenna size may be reduced while maintaining the antenna performance. The foresaid range may be obtained according to research and experiments.

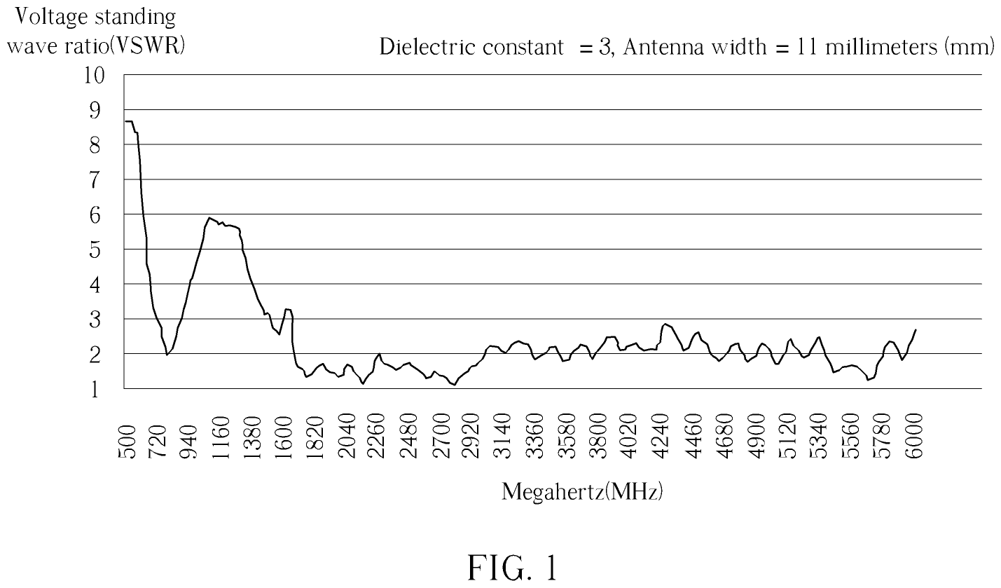

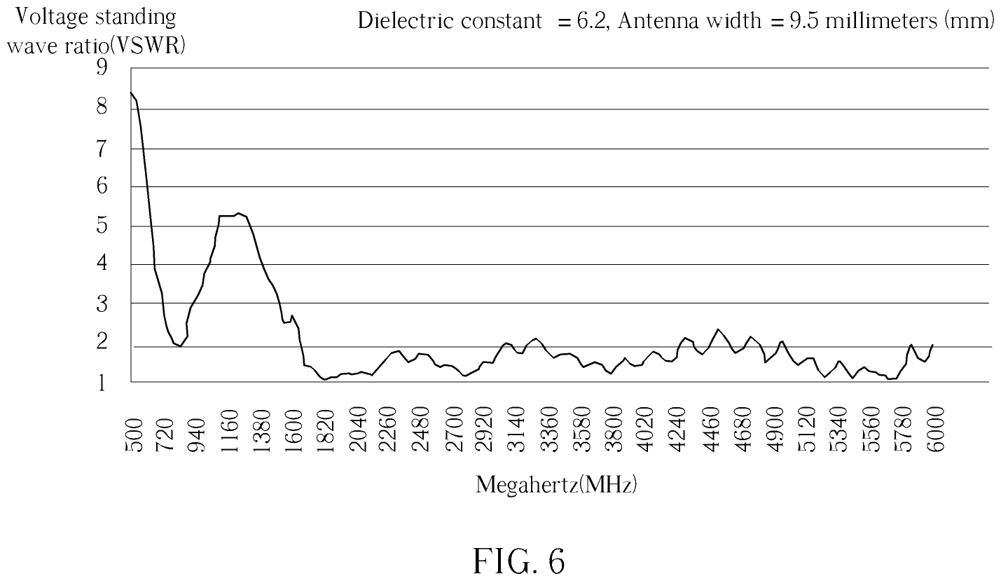

FIG. 6 illustrates a diagram of VSWR of the antenna 100. In FIG. 6, the horizontal axis is corresponding to signal frequency expressed in megahertz (MHz), and the vertical axis is corresponding to the VSWR. In an antenna of prior art corresponding to FIG. 1, a dielectric constant of a material of a carrier may be a conventional value such as 3, and a width of the antenna may be 11 mm. In the antenna 100, the dielectric constant of the material of the carrier may be within a range between 6 and 10. In FIG. 6, the dielectric constant may be 6.2, and the width of the antenna may be 9.5 mm. As shown in FIG. 1 and FIG. 6, the two figures are similar to one another. Particularly at a frequency band around 1000 MHz (i.e. 1 GHz), the bandwidths and the VSWRs are similar. Hence, by adjusting the range of the dielectric constant of the material of the carrier, the VSWR would be well kept, and the size of the antenna may be effectively reduced. For example, the width of the antenna may be reduced to 9.5 mm from 11 mm.

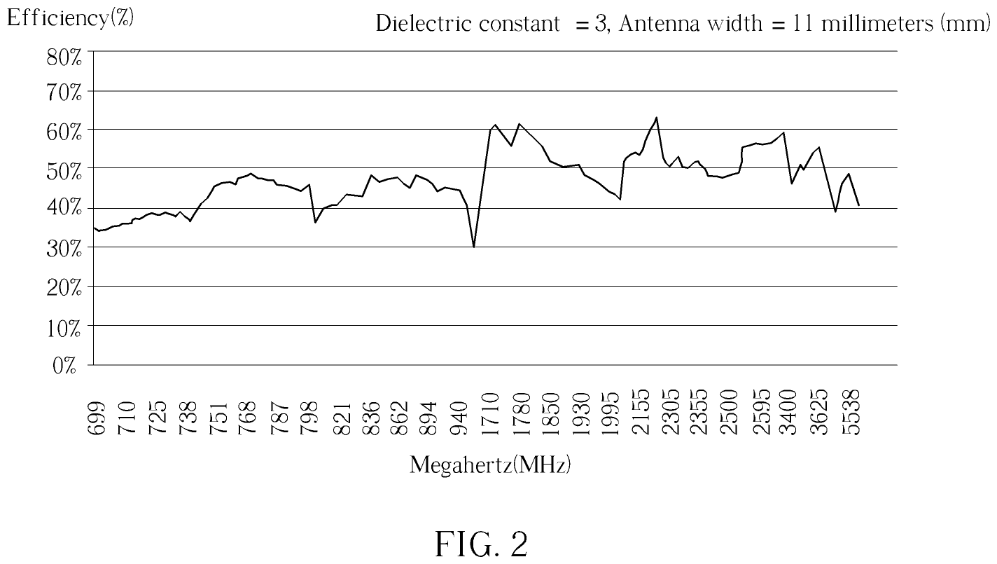

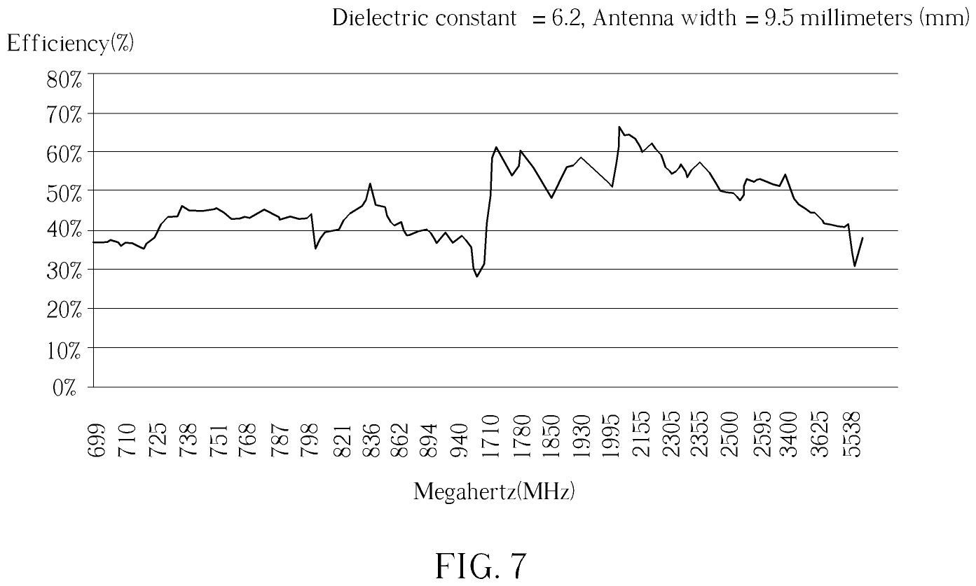

FIG. 7 illustrates an efficiency curve of the antenna 100 of FIG. 3 according to an embodiment. As FIG. 1 and FIG. 6, for example, in the antenna corresponding to FIG. 2, the dielectric constant of the material of the carrier may be 3, and the antenna width may be 11 mm. In the antenna corresponding to FIG. 7, the dielectric constant of the material of the carrier may be 6.2, and the antenna width may be 9.5 mm. As shown in FIG. 2 and FIG. 7, the efficiency curves in the two figures may be similar with one another. Hence, by adjusting the range of the dielectric constant of the material of the carrier, the efficiency curve of the antenna would be well kept, and the size of the antenna may be effectively reduced. For example, the width of the antenna may be reduced to 9.5 mm from 11 mm.

The antenna 100 shown in FIG. 3 to FIG. 5 may be a coupling antenna. In other words, the pattern of the conductive component 120 of the antenna 100 may be of a coupling antenna, but is not limited to a coupling antenna.

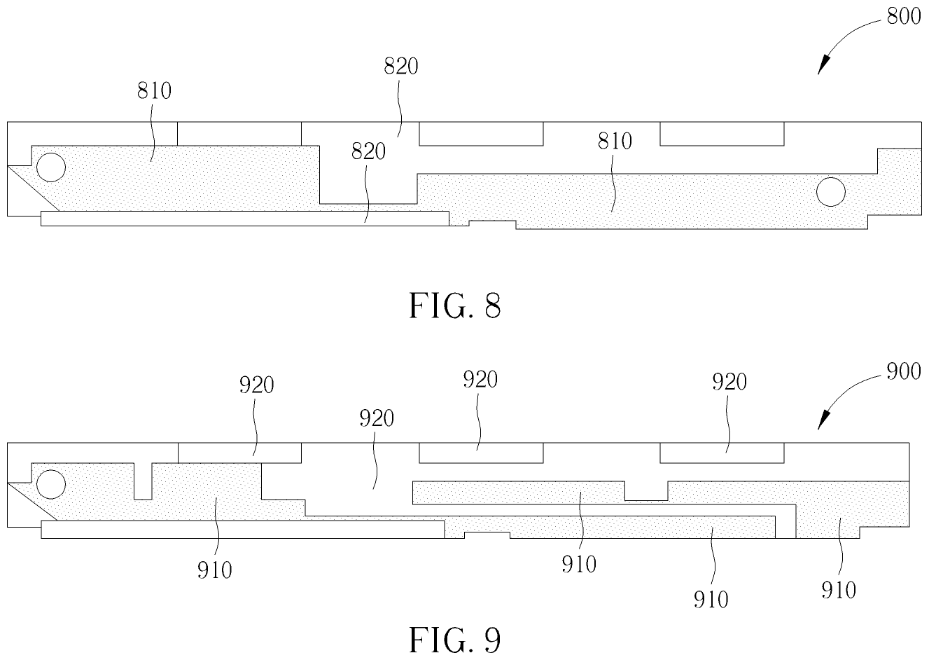

FIG. 8 illustrates an antenna 800 according to another embodiment. The antenna 800 may include a carrier 810 and a conductive component 820. The antenna 800 may be a monopole antenna. In other words, the conductive component 820 may have a pattern of a monopole antenna.

FIG. 9 illustrates an antenna 900 according to another embodiment. The antenna 900 may include a carrier 910 and a conductive component 920. The antenna 900 may be a planar inverted-F antenna (PIFA). In other words, the conductive component 920 may have a pattern of a planar inverted-F antenna.

As the embodiment in FIG. 3, a dielectric constant of a composite plastic material used to form the carrier 810 and a dielectric constant of a composite plastic material used to form the carrier 910 may be between a first value V1 and a second value V2. The sizes of the antenna 800 and 900 may be like the size of the antenna 100 each with a length of 80 mm and a width of 9.5 mm.

By adjusting the dielectric constant of the composite plastic material used to form the carrier, the antennas 800 and 900 may have smaller sizes than the antenna of prior art without losing antenna performance. In other words, the solution provided by embodiments may be used to manufacture coupling antennas, monopole antennas and planar inverted-F antennas.

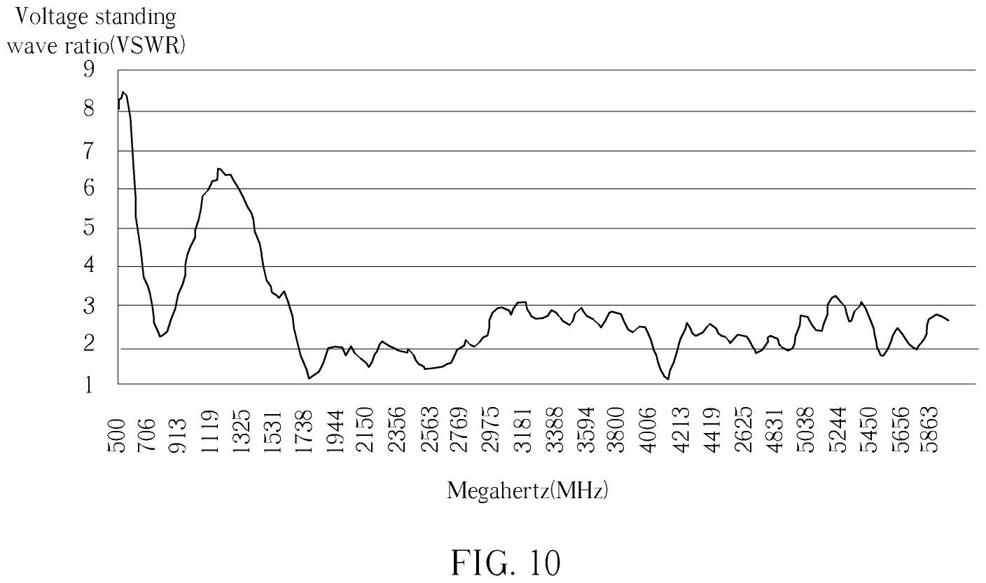

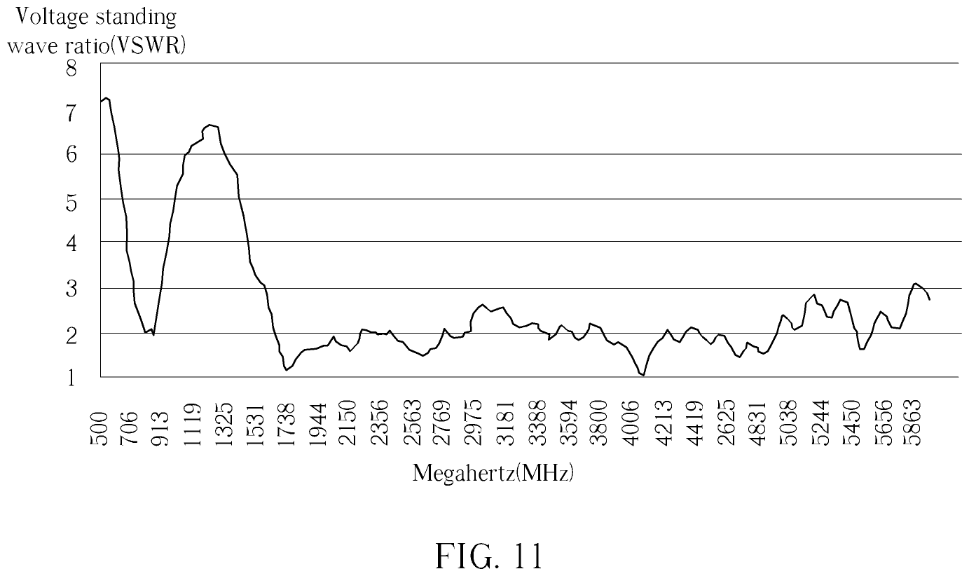

FIG. 10 illustrates a diagram of VSWR of the antenna 800. FIG. 11 illustrates a diagram of VSWR of the antenna 900. As shown in FIG. 6, FIG. 10 and FIG. 11, when a dielectric constant of a composite plastic material used to form a carrier is adjusted to a specific range (e.g., a range of 6 to 10), VSWR may be substantially kept without being worsened even if various types of antennas (e.g., coupling antenna, monopole antenna and planar inverted-F antenna) are manufactured.

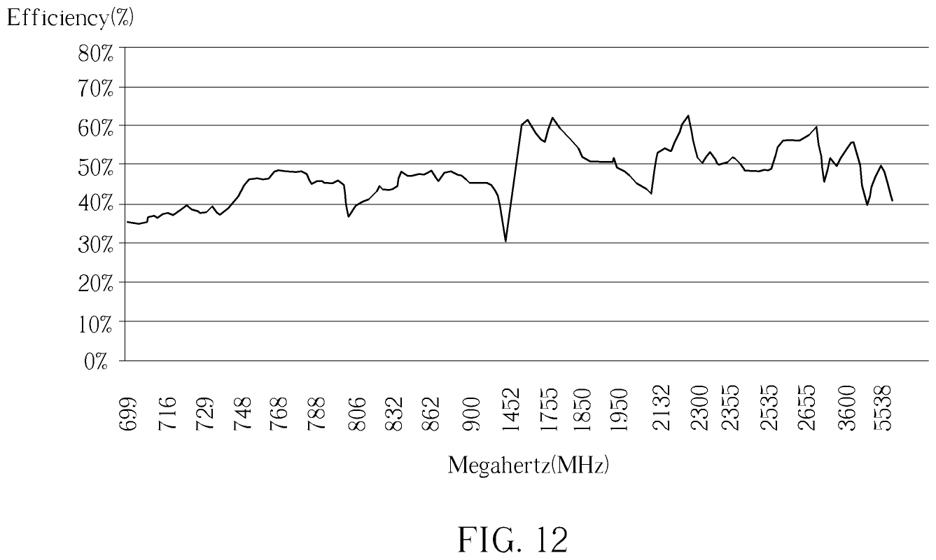

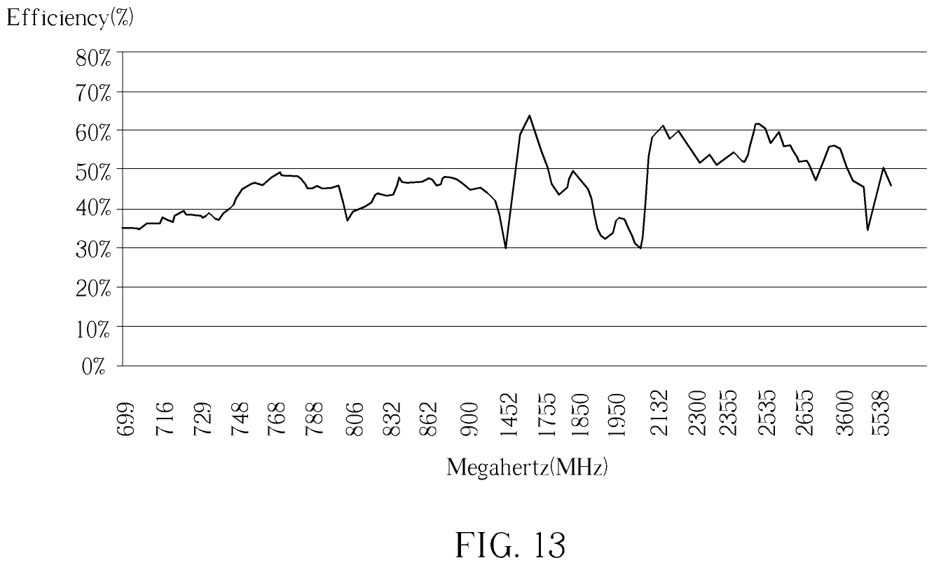

FIG. 12 illustrates an efficiency curve of the antenna 800. FIG. 13 illustrates an efficiency curve of the antenna 900. As shown in FIG. 7, FIG. 12 and FIG. 13, the efficiency curves may be similar. Hence, when a dielectric constant of a composite plastic material used to form a carrier is adjusted to a specific range (e.g., a range of 6 to 10), efficiency curves may be substantially kept without being worsened even if various types of antennas (e.g., coupling antenna, monopole antenna and planar inverted-F antenna) are manufactured.

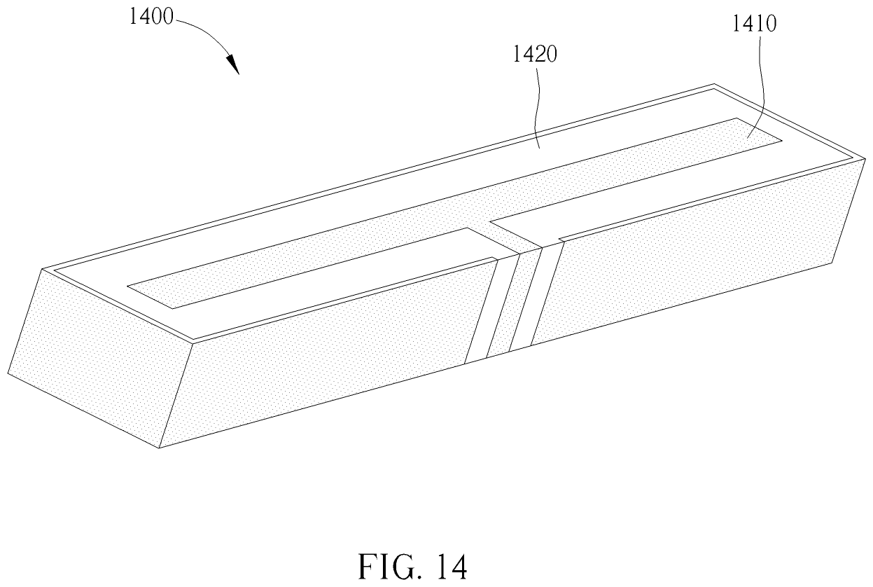

FIG. 14 illustrates an antenna 1400 according to another embodiment. The antenna 1400 may be a loop antenna including a carrier 1410 and a conductive component 1420. The carrier 1410 may be formed using a composite material having a dielectric constant between 6 to 10. By using the carrier 1410 with the dielectric constant between 6 to 10, the size of the antenna 1400 may be 45% less than the antenna of prior art.

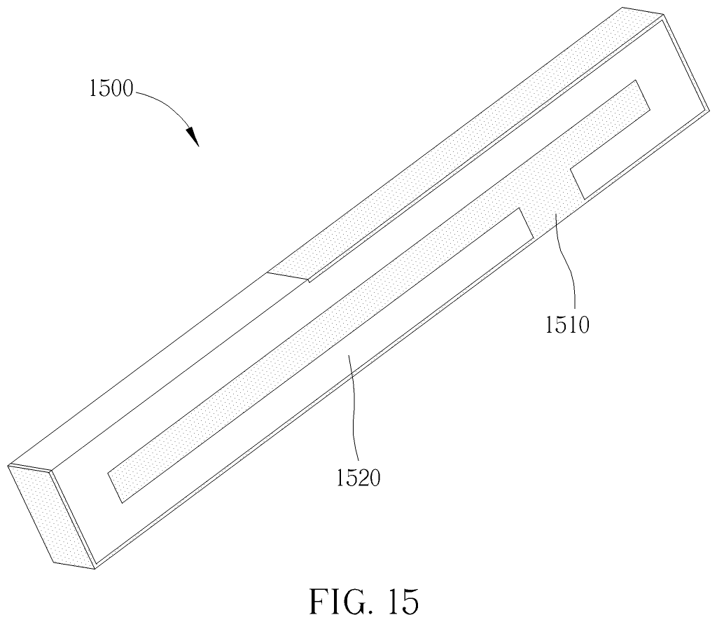

FIG. 15 illustrates an antenna 1500 according to another embodiment. The antenna 1500 may be an open-slot antenna including a carrier 1510 and a conductive component 1520. The carrier 1510 may be formed using a composite material having a dielectric constant between 6 to 10. By using the carrier 1510 with the dielectric constant between 6 to 10, the size of the antenna 1500 may be 45% less than the antenna of prior art.

In the antennas in FIG. 6, FIG. 7, FIG. 10 to FIG. 15, a conductive component and a pattern may be corresponding to a plurality of frequency bands. In other words, an antenna provided by an embodiment may support applications related to multiple bands and wideband. The antenna may be operated in a plurality of frequency bands, the frequency bands may be used for Long-Term Evolution (LTE) technology and/or New Radio (NR) technology, and the frequency bands may be between 500 MHz to 6 GHz. Hence, the antenna may be used for applications related to 5G mobile communications.

In summary, by means of an antenna provided by the embodiments, the antenna size may be reduced without lowering the antenna performance by adjusting a dielectric constant of a composite plastic material used to form a carrier to a specific range. For example, the specific range may be between 6 to 10 where the antenna may be operated at a frequency of around 1 GHz. Hence, the solution provided by embodiments can solve the problem in the field.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna comprising:
a carrier formed using a composite plastic material and configured to provide at least one containing area wherein the composite plastic material has a dielectric constant; and
at least one conductive component formed at the at least one containing area for combining with the carrier wherein the at least one conductive component forms a pattern;
wherein the dielectric constant is between a first value and a second value, the first value and the second value are larger than zero, the first value is smaller than the second value, and the first value is substantially equal to or larger than six.

2. The antenna of claim 1, wherein the second value is substantially equal to ten.

3. The antenna of claim 1, wherein the first value is substantially equal to seven and the second value is substantially equal to ten.

4. The antenna of claim 1, wherein the carrier and the at least one conductive component are generated and combined with one another using a laser direct structuring process, a flexible print circuit board, a metal stamping process or a metal spraying process.

5. The antenna of claim 1, wherein an area of the antenna is at least 30% smaller than an area of an original antenna, and a volume of the antenna is at least 45% smaller than volume of the original antenna.

6. The antenna of claim 1, wherein the conductive component has a length and a width, the length is substantially less than 85 millimeters, and the width is substantially less than 25 millimeters.

7. The antenna of claim 1, wherein the at least one conductive component and the pattern are corresponding to a plurality of frequency bands, the frequency bands are used for Long-Term Evolution technology and/or New Radio technology, and the frequency bands are between 500 megahertz to 6 gigahertz.

8. The antenna of claim 1, wherein the pattern is of a monopole antenna.

9. The antenna of claim 1, wherein the pattern is of a planar inverted-F antenna.

10. The antenna of claim 1, wherein the pattern is of a coupling antenna.

11. The antenna of claim 1, wherein the pattern is of a loop antenna.

12. The antenna of claim 1, wherein the pattern is of an open-slot antenna.
